(19) United States
(12) Patent Application Publication
(10) Pub. No.: US 2007/0200540 A1
(43) Pub. Date: Aug. 30, 2007

(54) Power Source Device

(75) Inventors: Ken Hashimoto, Kyoto (JP); Kenichi Niiyama, Kyoto (JP)

Correspondence Address: CANTOR COLBURN, LLP, 55 GRIFFIN ROAD SOUTH, BLOOMFIELD, CT, 06002, US

(73) Assignee: ROHM CO., LTD., Kyoto (JP)

(21) Appl. No.: 11/632,478

(22) PCT Filed: Jun. 29, 2005
(86) PCT No.: PCT/JP05/11999

§ 371 Date: Jan. 16, 2007

(30) Foreign Application Priority Data
Jul. 14, 2004 (JP) 2004-206799

(51) Int. Cl. G05F 1/00

(52) U.S. Cl. 323/282

(57) ABSTRACT

A power supply apparatus is provided in the exemplary embodiments. The voltage generation circuit has a switching element. The control circuit controls a switching operation of the switching element. The voltage comparator compares an output voltage from the voltage generation circuit with a predetermined test voltage. The timer circuit is activated, when the output voltage from the voltage generation circuit is lower than the test voltage, and then measures elapsed time. The control circuit stops the switching operation of the switching element when the elapsed time measured by the timer circuit has exceeded a predetermined period of time.

### TECHNICAL FIELD

The present invention relates to a power supply apparatus, and in particular to a power supply apparatus which employs a switching element to provide protection against short circuits.

### RELATED ART

Recently, battery operated compact information terminal devices have become available, which include, for example, portable CD players, digital still cameras, and cellular phones. These devices include circuits that do not necessarily require the battery voltage itself as their power supply voltages. That is, some circuits used within a compact information terminal device may require a voltage higher than the battery voltage, whereas others may require a voltage lower than the battery voltage. In such a case, to obtain a desired voltage, a switching regulator or the like is used to step up or down the battery voltage, thereby supplying the appropriate power supply voltage to each circuit.

However, during manufacturing or after the shipment of a compact information terminal device, the power supply apparatus may be connected at its output terminal to a load circuit in which a short circuit may occur for some reason or another. In such a case, when a step-up or step-down operation is maintained for the power supply apparatus to output the desired voltage, a high current would keep flowing into the load circuit, resulting in the reliability of the entire circuit being degraded due to heat generation. In this context, such a power supply apparatus will require a technique which can detect a short circuit in a load circuit so as to provide protection against the short circuit. A technique for a power supply apparatus to provide protection against short circuits has been suggested, e.g., in Patent Document 1.
[Patent Document 1] Japanese Patent Laid-Open Publication No. Hei 6-311734

### DISCLOSURE OF THE INVENTION

Problems to be Solved by the Invention

Like the technique described in the aforementioned document, a purpose of the present invention is to provide means which detects a short circuit in a load circuit to provide protection against the short circuit; however, the present invention is intended to achieve the purpose in a different approach from that of the technique described in the aforementioned document. It is an general purpose of the present invention to provide a power supply apparatus that includes a short circuit protection capability of detecting a short circuit in a load circuit to provide circuit protection.

Means for Solving the Problems

In order to achieve the aforementioned object, a power supply apparatus according to an embodiment of the present invention includes a voltage generation circuit having a switching element; a control circuit which controls a switching operation of the switching element; a voltage comparator which compares an output voltage from the voltage generation circuit with a predetermined test voltage; and a timer circuit to be activated, when the output voltage from the voltage generation circuit is lower than the test voltage, to measure elapsed time. The control circuit stops the switching operation of the switching element when the elapsed time measured by the timer circuit has exceeded a predetermined period of time.

As used herein, the expression “the voltage generation circuit having a switching element” refers to a circuit for turning on or off a switch to perform energy conversion using a capacitor or an inductor, thereby generating a desired voltage. The circuit includes, for example, a step-up, step-down, and voltage inversion circuit which employ the switching regulator scheme or the switched capacitor scheme.

A short circuit occurring in a load circuit would cause the output voltage to be kept at a lower voltage than the predetermined test voltage. Accordingly, the timer circuit can be used to measure the period of time, during which the output voltage is lower than the predetermined test voltage, for comparison with a predetermined period of time, thereby determining the presence or absence of a short circuit in the load circuit.

The timer circuit may include a capacitor with one end connected to the ground; a constant current source connected to the other end of the capacitor; and a voltage comparator which compares the voltage at the other end of the capacitor with a predetermined reference voltage. The elapsed time measured by the timer circuit may be associated with the voltage at the other end of the capacitor which is to be charged by the constant current source, while the predetermined period of time may be associated with the predetermined reference voltage.

Charging the capacitor by the constant current source allows the capacitor to output a voltage proportional to time, thereby enabling time to voltage conversion. Thus, a comparison of this voltage with the predetermined voltage makes it possible to detect that a predetermined period of time has elapsed.

Another embodiment of the present invention also relates to a power supply apparatus. The power supply apparatus includes a voltage generation circuit having a switching element; a control circuit which controls a switching operation of the switching element; a timer circuit which outputs a signal of a predetermined level when a predetermined period of time has elapsed from an initiation of a switching operation; and a voltage comparator to be activated, when the signal of a predetermined level is output from the timer circuit, to compare an output voltage from the voltage generation circuit with a predetermined test voltage. The control circuit stops the switching operation of the switching element when the output voltage from the voltage generation circuit is lower than the test voltage.

According to this embodiment, the timer circuit measures time to determine that a short circuit has occurred in a load circuit, when the output voltage has not yet reached a predetermined voltage after a certain period of time has elapsed. Then, the switching operation of the switching element is stopped, thereby making it possible to stop the current supply to the load circuit.

The timer circuit may include a capacitor with one end connected to the ground; a constant current source connected to the other end of the capacitor; and a voltage comparator which compares a voltage at the other end of the capacitor with a predetermined voltage. The timer circuit may output the signal of a predetermined level when the voltage at the other end of the capacitor is higher than the predetermined voltage.

According to this embodiment, charging the capacitor by the constant current source allows the capacitor to output a voltage proportional to time,. thereby enabling time to voltage conversion. A comparison of this voltage with the predetermined voltage makes it possible to measure that a predetermined period of time has elapsed.

The control circuit may perform the switching operation of the switching element with a predefined fixed duty during a predetermined starting period from the initiation of the switching operation.

In this case, during the starting period, the output voltage from the voltage generation circuit can be raised if no short circuit is detected in the load circuit. On the other hand, if a short circuit is detected, the switching operation is stopped and thus the switching element is driven with a fixed duty, thereby making it possible to prevent a current from constantly flowing into the load circuit.

In contrast to this, the control circuit may stop not only the switching operation of the switching element but also the load circuit connected to the output terminal of the voltage generation circuit.

Stopping the operation of the load circuit, in keeping with ceasing the switching of the voltage generation circuit, reduces the current flowing from the voltage generation circuit, thereby preventing heat generation in the circuit in a more preferred manner.

As described above, the present invention determines that a detection has been made by a load circuit when either: 1. The output voltage has not reached a predetermined voltage after a certain period of time has elapsed from an initiation of the power supply apparatus, or 2. The measured period of time for the output voltage to reach the predetermined voltage is too long.

Note that any combinations of the aforementioned components, and the components and representations of the present invention exchanged between methods, apparatuses, or systems are also included in the embodiments of the present invention.

Advantages of the Invention

The power supply apparatus according to the present invention can provide protection to circuits.

### BRIEF DESCRIPTION OF THE DRAWINGS

FIG. 1 is a circuit diagram illustrating a power supply apparatus according to an embodiment of the present invention.

FIGS. 2A and 2B are views illustrating a normal operating condition in which no short circuit has occurred in a load circuit connected to an output terminal of the power supply apparatus of FIG. 1.

FIGS. 3A and 3B are views illustrating an abnormal operating condition in which a short circuit has occurred in a load circuit connected to the output terminal of the power supply apparatus of FIG. 1.

FIG. 4 is a view illustrating a modified example of the short-circuit detect circuit of FIG. 1.

FIG. 5 is a block diagram illustrating the configuration of an electronic apparatus into which the power supply apparatus of FIG. 1 is incorporated.

### EXPLANATION OF SYMBOLS

SW1: Main Switch, SW2: Synchronous Rectification Switch, SW3: Switch, Co: Output Capacitor, Cx: Short-Circuit Detect capacitor, 10: Driver Circuit, 12: Voltage Comparator, 14: Oscillator, 16: Starter Circuit, 18: Error Amplifier, 20: Voltage Comparator, 22: Voltage Comparator, 24: Constant Current Source, 26: Timer Circuit, 30: Switching Regulator, 32: Regulator, 34: Control Circuit, 36: Short-circuit Detect circuit, 40: Short-Circuit Detect circuit, 100: Power supply apparatus

### BEST MODE FOR CARRYING OUT THE INVENTION

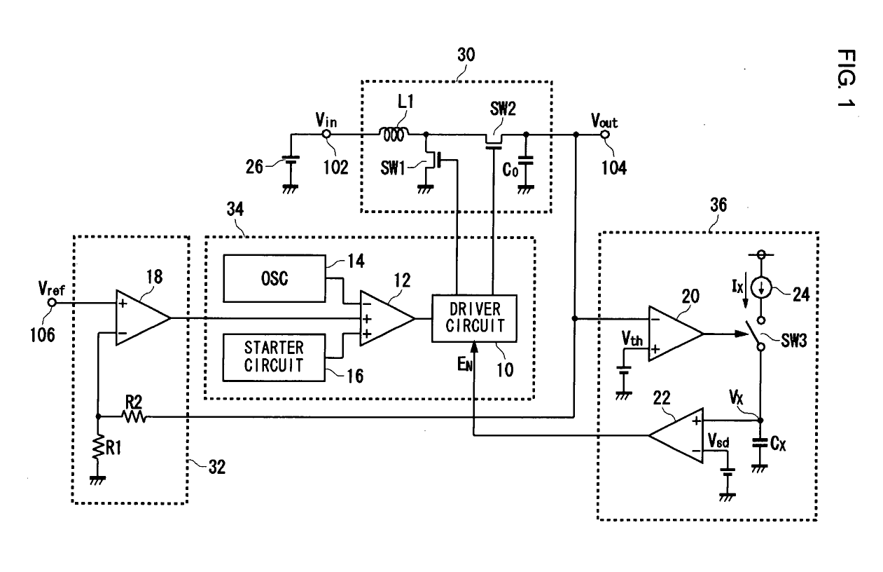

FIG. 1 is a circuit diagram illustrating a power supply apparatus 100 according to an embodiment of the present invention. The power supply apparatus 100, which is a step-up converter based on a synchronous rectification scheme, allows a switching regulator to step up a voltage supplied to an input terminal 102 for output to an output terminal 104.

The power supply apparatus 100 includes the input terminal 102, the output terminal 104, and a reference voltage terminal 106. The input terminal 102 is supplied with an input voltage Vin. Furthermore, the reference voltage terminal 106 is supplied with a reference voltage Vref for adjusting an output voltage Vout to be delivered from the output terminal 104. The power supply apparatus 100 may also generate the reference voltage Vref therein.

FIG. 5 is a block diagram illustrating the configuration of an electronic apparatus 300 into which the power supply apparatus 100 of FIG. 1 is incorporated. The electronic apparatus 300 is a battery-powered portable device such as a portable CD player, a digital still camera, or a cellular phone terminal device, in which there are included: a battery 310, the power supply apparatus 100, and a load 320. The battery 310, which may be a lithium ion battery or the like, generates a battery voltage Vbat of about 3 to 4V for output to the input terminal 102 of the power supply apparatus 100. That is, the battery voltage Vbat is the input voltage Vin of FIG. 1. Furthermore, the output terminal 104 of the power supply apparatus 100 is connected with the load circuit 320. The load circuit 320 is a device which requires a higher voltage than the battery voltage Vbat, e.g., for LEDs (Light Emitting Diodes) or CCDs (Charge Coupled Devices).

Again, reference is made to FIG. 1. The power supply apparatus 100 includes a switching regulator 30, a regulator 32, a control circuit 34, and a short-circuit detect circuit 36. The regulator 32, the control circuit 34, and the short-circuit detect circuit 36 are integrated on one semiconductor substrate as a functional IC.

The switching regulator 30, which is a typical step-up converter based on a synchronous rectification scheme, includes an inductor L1, a main switch SW1, a synchronous rectification switch SW2, and an output capacitor Co, and is designed such that the control circuit 34 is used to alternately turn on or off the main switch SW1 and the synchronous rectification switch SW2, thereby stepping up the input voltage Vin so as to output the output voltage Vout to the output terminal 104. The main switch SW1 and the synchronous rectification switch SW2, which are MOSFETs (Metal Oxide Semiconductor Field Effect Transistor), are provided with on or off control by the voltage input to their respective gate terminals.

The regulator 32, which includes resistors R1 and R2, and an error amplifier 18, is a circuit for stabilizing the output voltage Vout in accordance with the reference voltage Vref supplied to the reference voltage terminal 106. The error amplifier 18, which includes a non-inverting input terminal and an inverting input terminal, adjusts its output or an error voltage Verr so that the values at both the input terminals are equal to each other. The inverting input terminal of the error amplifier 18 is supplied with Vout×R1/(R1+R2) as a feedback input, for which the output voltage Vout is averaged by the voltage divider consisting of the resistor R1 and the resistor R2. On the other hand, to the non-inverting input terminal of the error amplifier 18 is applied the reference voltage Vref. Accordingly, the regulator 32 provides feedback such that Vout=Vref×(R1+R2)/R1 holds between the output voltage Vout and the reference voltage Vref, thereby allowing the output voltage Vout to be stabilized.

The control circuit 34 generates a switching signal for turning on or off a switching element of the switching regulator 30 in accordance with the error voltage Verr output from the regulator 32. The control circuit 34 includes an oscillator 14, a starter circuit 16, a voltage comparator 12, and a driver circuit 10. The oscillator 14 generates a cyclic voltage Vosc in the shape of a triangular wave or a sawtooth wave at a certain frequency. The starter circuit 16, which is used in a startup period, outputs a start voltage Vst for turning on or off the switches SW1 and SW2 of the switching regulator 30 with a fixed duty.

During the startup period of the power supply apparatus 100, the voltage comparator 12 compares the start voltage Vst delivered from the starter circuit 16 with the cyclic voltage Vosc delivered from the oscillator 14, and outputs a pulse-width modulation signal (hereinafter referred to as the PWM signal Vpwm) which is at a high level when Vst>Vosc. After the startup, the voltage comparator 12 also compares the error voltage Verr, delivered from the regulator 32, with the cyclic voltage Vosc to generate the PWM signal Vpwm which is at a high level when Verr>Vosc. The duty ratio of the resulting PWM signal Vpwm is fixed during the startup period and varies depending on the error voltage Verr after the startup.

The driver circuit 10 alternately turns on or off the main switch SW1 and the synchronous rectification switch SW2 in accordance with the PWM signal Vpwm. The driver circuit 10 outputs two switching signals, which are supplied to the gate terminal of the main switch SW1 and the synchronous rectification switch SW2, respectively, to control their switching operation. While the PWM signal Vpwm is at a low level, the signals turn on the main switch SW1 and turn off the synchronous rectification switch SW2, respectively. Conversely, while the PWM signal Vpwm is at a high level, the signals turn off the main switch SW1 and turn on the synchronous rectification switch SW2, respectively. Turning on the main switch SW1 causes a current to flow via the inductor L1 and the main switch SW1, allowing energy to be stored in the inductor L1. Turning on the synchronous rectification switch SW2 causes the current, which was flowing through the inductor L1 when the main switch SW1 was in the on state, to flow into the output capacitor Co via the synchronous rectification switch SW2. The main switch SW1 and the synchronous rectification switch SW2 are alternately turned on or off in accordance with the duty of the PWM signal Vpwm so as to step up and smooth the input voltage Vin, which is in turn delivered as the output voltage Vout from the output terminal 104.

The driver circuit 10, which includes an enable terminal EN, also fixes the two switching signals at the ground potential when a high level is supplied to the enable terminal EN, and then stops the switching operation of the main switch SW1 and the synchronous rectification switch SW2, thereby stopping the voltage step-up operation of the switching regulator 30.

The PWM signal Vpwm, for providing on or off control to the main switch SW1 and the synchronous rectification switch SW2 of the switching regulator 30, is determined based on the error voltage Verr that is obtained through the feedback of the output voltage Vout. Accordingly, the output voltage Vout is maintained at a certain value that is determined by the reference voltage Vref.

Now, a description will be given as to the configuration of the short-circuit detect circuit 36, which is a feature of the power supply apparatus 100 according to this embodiment. The short-circuit detect circuit 36, which includes a voltage comparator 20 and a timer circuit 26, detects a short circuit in a load circuit connected to the output terminal 104 of the power supply apparatus 100.

The voltage comparator 20 compares the output voltage Vout with a predetermined test voltage Vth to output a high level when Vth>Vout or a low level when Vth<Vout.

The timer circuit 26, which includes a voltage comparator 22, a constant current source 24, a switch SW3, and a short-circuit detect capacitor Cx, is activated to measure the elapsed time when the output voltage Vout from a voltage generation circuit 30 is lower than the test voltage Vth. The timer circuit 26 outputs a stop signal SIG1 of a high level when the measured period of time has exceeded a predetermined period of time.

The constant current source 24 allows a current of a constant current value Ix to flow into the short-circuit detect capacitor Cx via the switch SW3. The short-circuit detect capacitor Cx has one end connected to the ground and the other end connected to the constant current source 24 via the switch SW3. The short-circuit detect capacitor Cx is charged with the constant current Ix supplied by the constant current source 24, so that while the switch SW3 is in an on state, the voltage Vx of the short-circuit detect capacitor Cx is proportional to time. The timer circuit 26 configured as such is activated when the switch SW3 is on and measures time.

The voltage comparator 22 is supplied with a shutdown voltage Vsd and the voltage Vx. The voltage comparator 22 compares between the two voltages to output the stop signal SIG1 of a high-level to the enable terminal EN of the driver circuit 10 in the control circuit 34 when the voltage Vx is higher than the shutdown voltage Vsd.

The voltage comparator 20 supplies its output to the switch SW3. The switch SW3 is turned on when a high level is supplied thereto and turned off when a low level is supplied thereto. The switch SW3 can be formed of, for example, a MOSFET or bipolar transistor so as to be turned on or off by its gate voltage or base voltage being varied. The short-circuit detect circuit 36 configured in this manner measures the period of time during which the output voltage Vout is lower than the detection voltage Vth, and when this period of time has exceeded a predetermined period of time, determines that the load circuit is short-circuited and outputs the stop signal SIG1 of a high level.

The stop signal SIG1 is supplied to the enable terminal EN of the driver circuit 10. As described above, a high level supplied to the enable terminal EN causes the driver circuit 10 to stop the switching operation of the main switch SW1 and the synchronous rectification switch SW2. In this manner, when the elapsed time measured by the timer circuit 26 has exceeded the predetermined period of time, the control circuit 34 stops the switching operation of the switching element.

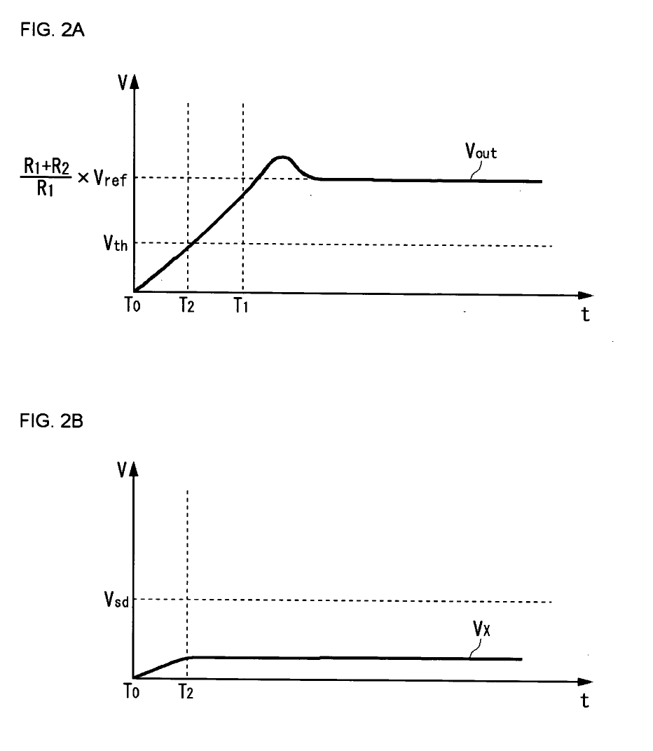

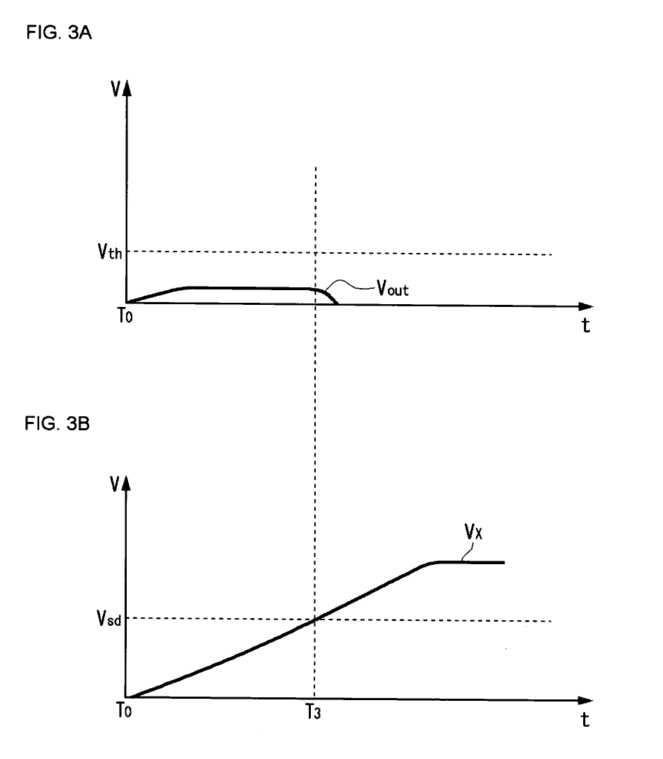

A description will now be given as to the operation of the power supply apparatus 100 configured as described above, with reference to FIGS. 2A and 2B and FIGS. 3A and 3B. FIGS. 2A and 2B are views illustrating a normal operating condition in which no short circuit has occurred in a load circuit connected to the output terminal 104 of the power supply apparatus 100. FIGS. 3A and 3B are views illustrating an abnormal operating condition in which a short circuit has occurred in a load circuit connected to the output terminal 104 of the power supply apparatus 100.

First, referring to FIGS. 2A and 2B, a description will be given as to the normal operating condition in which no short circuit has occurred in the load circuit.

At time T0, the voltage step-up operation of the power supply apparatus 100 is initiated. During the period of time from T0 to T1, the output from the starter circuit 16 used at the time of initiation of the power supply apparatus 100 is active, and the output voltage Vout is stepped up with a fixed duty until time T1.

With the output voltage Vout>V1, the output from the starter circuit 16 is turned off, and the error voltage Verr of the error amplifier 18 is adjusted so that Vout=(R1+R2)/R2×Vref as described above. Based on the error voltage Verr, the voltage comparator 12 produces the PWM signal Vpwm. The main switch SW1 and the synchronous rectification switch SW2 are turned on or off in accordance with the duty of the PWM signal Vpwm, thereby allowing the driver circuit 10 to raise the input voltage Vin up to a desired voltage. An adjustment being made to the error voltage Verr through feedback allows the output voltage Vout to approach a voltage given by (R1+R2)/R2×Vref.

Meanwhile, the short-circuit detect circuit 36 performs the following operation. In FIG. 2A, during the period of time from T0 to T1 or a startup period, the output voltage Vout is raised with a fixed duty thus increasing gradually. During this period of time, since it holds in the voltage comparator 20 that Vth>Vout, the switch SW3 is on. The switch SW3 being on causes the short-circuit detect capacitor Cx to be charged with the current Ix fed from the constant current source 24 and thus causes the voltage Vx to increase gradually with time. Assuming tx is the elapsed time from the initiation of charging by the constant current source 24, the voltage Vx of the short-circuit detect capacitor Cx is given by Vx=Ix/Cx×tx, increasing in proportion to time.

At time T2, the output voltage Vout is higher than the test voltage Vth, and the switch SW3 is turned off to block the current supplied from the constant current source 24. Since the charging of the short-circuit detect capacitor Cx is stopped at this time, the voltage Vx takes on a constant value. Thereafter, since there will be no increase in the voltage Vx, a voltage comparison performed at the voltage comparator 22 would allow the voltage Vx to be always smaller than the shutdown voltage Vsd. Hence a low level is supplied to the enable terminal EN of the driver circuit 10, thereby never causing the voltage step-up operation to be stopped at the switching regulator 30. When the startup period ends at time T1, the starter circuit 16 is inactivated, and the PWM signal Vpwm is generated based on the error voltage Verr delivered from the regulator 32, allowing the output voltage Vout to approach a desired voltage.

Referring to FIGS. 3A and 3B, a description will now be given as to an operating condition in which there is a short circuit in a load circuit connected to the output terminal 104 of the power supply apparatus 100.

At time TO, voltage step-up operation of the power supply apparatus 100 is initiated. At time T0, the output from the starter circuit 16 used at the time of starting the voltage step-up operation is activated, and the switching of the switching regulator 30 is controlled with a fixed duty, allowing for starting the voltage step-up operation to increase the output voltage Vout. However, at this time, since the load circuit connected to the output terminal 104 of the power supply apparatus 100 is short-circuited, the output voltage Vout will not become higher than a certain value in the vicinity of OV, as shown in FIG. 3A.

As a result, the following operation will be performed in the short-circuit detect circuit 36. Since the switch SW3 is kept on when Vout<Vth, the voltage Vx of the short-circuit detect capacitor Cx is charged with the current Ix fed from the constant current source 24 and allowed to keep increasing with a gradient of Ix/Cx. After a while, at time T3, the voltage Vx of the short-circuit detect capacitor Cx becomes higher than the shutdown voltage Vsd. The time T3 is given by T3=Vsd/Ix×Cx. In the voltage comparator 22, with Vsd<Vx at time T3, the enable terminal EN of the driver circuit 10 is supplied with a high level, and the voltage step-up operation of the switching regulator 30 is stopped. The voltage step-up operation can be stopped by each of the two switching signals delivered from the driver circuit 10 being lowered to the ground potential.

Since charges being supplied to the output capacitor Co are stopped and discharged only to the load circuit when the voltage step-up operation of the switching regulator 30 is stopped at time T3, the output voltage Vout is lowered to the vicinity of the ground potential, thereby preventing a high current from flowing into the load circuit.

At this stage, the operation of the load circuit connected to the output terminal 104 may also be stopped together. Stopping the operation of the load circuit makes it possible to reduce the current flowing from the power supply apparatus 100, thereby more effectively preventing heat generation in the circuit.

Furthermore, in a case where the power supply apparatus 100 is incorporated into a set, a signal may be provided to inform a circuit for collectively controlling the set of a short circuit in a load circuit. For a test of the set during its manufacture, this signal allows the manufacturer to detect a short circuit in the load circuit before shipment and troubleshoot its cause. On the other hand, even after the shipment of the set, the circuit for collectively controlling the set can provide appropriate information, e.g., to inform the user of its failure.

As described above, according to the power supply apparatus 100 of this embodiment, the short-circuit detect circuit 36 detects a short circuit in a load circuit, and both the main switch SW1 and the synchronous rectification switch SW2 of the switching regulator 30 are turned off to stop the switching operation and block the current being supplied to the load circuit, thereby making it possible to prevent a high current from flowing therein.

On the other hand, as shown in FIGS. 2A and 2B, when no short-circuit failure is found in the load circuit, no influence is exerted on the operation of the switching regulator 30.

It will be appreciated by those skilled in the art that the aforementioned embodiment is only illustrative, and various modifications may be made to the combination of its components and process steps and such modifications also fall within the scope of the present invention.

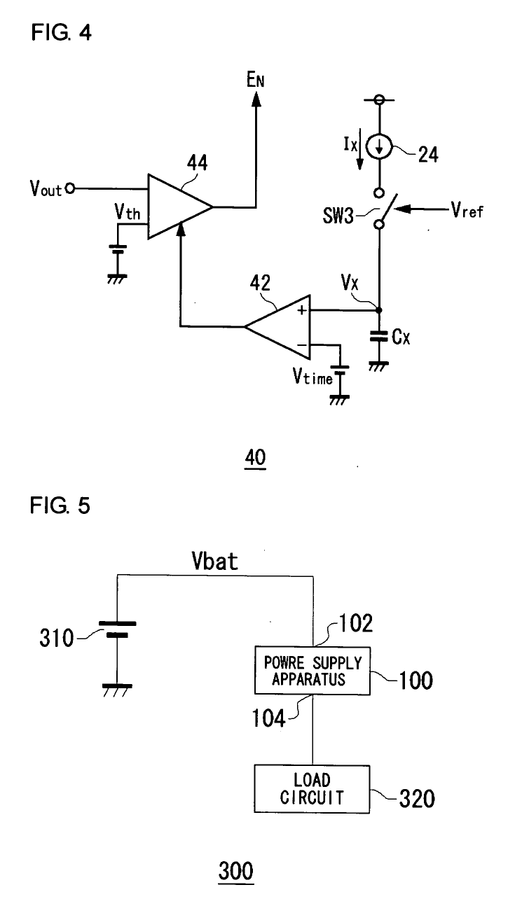

For example, the short-circuit detect circuit 36 used in this embodiment can be replaced with a short-circuit detect circuit 40 shown in FIG. 4. When the output voltage Vout has not reached a predetermined test voltage Vth in a certain period of elapsed time after the initiation of the power supply apparatus 100, the short-circuit detect circuit 40 determines that a short circuit has occurred in a load circuit.

The short-circuit detect circuit 40 includes a timer circuit 26 and a voltage comparator 44. The timer circuit 26 is configured in the same manner as in FIG. 1. The short-circuit detect capacitor Cx is charged with the constant current Ix fed by the constant current source 24, and while the switch SW3 is in an on state, the voltage Vx of the short-circuit detect capacitor Cx serves as a timer circuit that increases with time. The switch SW3 is provided with on or off control in accordance with the reference voltage Vref, and turned on when the reference voltage Vref supplied has a certain value or greater. While the switch SW3 is on, the timer circuit 26 is activated to start to measure time.

A voltage comparator 42 is supplied with the voltage Vx of the short-circuit detect capacitor Cx and a voltage Vtime. When the short-circuit detect capacitor Cx is charged so that when Vx>Vtime, the voltage comparator 42 outputs a signal of a high level. When the reference voltage Vref is supplied at the same time as the initiation of a voltage step-up operation to turn on the switch SW3, the timer circuit 26 is to output a signal of a predetermined level when a predetermined period of time has elapsed from the initiation of the switching operation. The output from the voltage comparator 42 is supplied to the voltage comparator 44. That is, the timer circuit 26 measures a certain period of time defined by the voltage Vtime, and then informs the voltage comparator 44 that the period of time has elapsed.

The voltage comparator 44 makes a voltage comparison only when the output from the voltage comparator 42 is at a certain level, i.e., a high level. The voltage comparator 44, to which the output voltage Vout from the power supply apparatus 100 and the test voltage Vth are supplied, turns its output into a high level when Vout<Vth. The output of the voltage comparator 44 is connected to the enable terminal EN of the driver circuit 10 of FIG. 1. Accordingly, the control circuit 34 stops the switching operation of the main switch SW1 and the synchronous rectification switch SW2 when the timer circuit 26 outputs a high level and the output voltage Vout from the voltage generation circuit 30 is lower than the test voltage Vth.

If no short circuit has occurred in the load circuit of the power supply apparatus 100, the output voltage Vout may have become greater than a certain voltage in a certain period of elapsed time after the initiation of a voltage step-up operation. Conversely, if a short circuit has occurred in the load circuit, the output voltage Vout will never increase so that Vout<Vth even after a certain period of time has elapsed, thereby making it possible to detect a short circuit in the load circuit. The time at which these voltages are compared with each other can be adjusted using the voltage Vtime, the short-circuit detect capacitor Cx, and the constant current Ix.

Furthermore, although this embodiment employs an N-type MOSFET as the main switch SW1 and the synchronous rectification switch SW2; however, the present invention is not limited thereto. It is also possible to use a P-type MOSFET if the logic and voltage for driving the gate voltage by the driver circuit 10 are changed. It is also possible to use other types of transistors such as bipolar transistors in place of MOSFETs so long as those transistors can only work as a switching element. Such selections may be made in accordance with, e.g., the design specification required for the power supply apparatus or the semiconductor manufacturing process employed.

The embodiment employs a step-up converter based on the synchronous rectification scheme as the switching regulator 30; however, the present invention is not limited thereto but can alternatively employ a power supply circuit having another switching element. The power supply circuit having a switching element means to include, in place of the synchronous rectification switch, a switching regulator using a rectifying diode based on the diode rectification scheme, a step-up circuit and step-down circuit, which are based on the switched capacitor scheme, and a voltage inversion circuit.

In this embodiment, all the components constituting the power supply apparatus 100 may be integrated into one piece, or alternatively part of them may be formed of a discrete component. It may be determined based on costs and occupied areas which components are to be integrated.

### INDUSTRIAL APPLICABILITY

The power supply apparatus according to the present invention makes it possible to provide circuit element protection against a short circuit in a load circuit.

1. A power supply apparatus comprising:
a voltage generation circuit having a switching element;
a control circuit which controls a switching operation of the switching element;
a voltage comparator which compares an output voltage from the voltage generation circuit with a predetermined test voltage; and
a timer circuit to be activated, when the output voltage from the voltage generation circuit is lower than the test voltage, to measure elapsed time, wherein
the control circuit stops the switching operation of the switching element when the elapsed time measured by the timer circuit has exceeded a predetermined period of time.

2. A power supply apparatus comprising:
a voltage generation circuit having a switching element;
a control circuit which controls a switching operation of the switching element;
a timer circuit which outputs a signal of a predetermined level when a predetermined period of time has elapsed from an initiation of a switching operation; and
a voltage comparator to be activated, when the signal of a predetermined level is output from the timer circuit, to compare an output voltage from the voltage generation circuit with a predetermined test voltage, wherein
the control circuit stops the switching operation of the switching element when the output voltage from the voltage generation circuit is lower than the test voltage.

3. The power supply apparatus according to claim 1, wherein the control circuit performs the switching operation of the switching element with a predefined fixed duty during a predetermined starting period from the initiation of the switching operation.

4. The power supply apparatus according to claim 1, wherein the control circuit stops not only the switching operation of the switching element but also the load circuit connected to the output terminal of the voltage generation circuit.

5. The power supply apparatus according to claim 1, wherein the control circuit, the voltage comparator, and the timer circuit are integrated on one semiconductor substrate.

6. An electronic apparatus comprising:
a battery; and
the power supply apparatus according to claim 1, which steps up or down a voltage of the battery for output.

7. A method for controlling a voltage generation circuit having a switching element, comprising:
performing a voltage comparison between an output voltage from the voltage generation circuit and a predetermined test voltage;
measuring a period of time while the output voltage from the voltage generation circuit is lower than the test voltage; and
stopping a switching operation of the switching element when a period of time measured through the time measurement has exceeded a predetermined period of time.

8. A method for controlling a voltage generation circuit having a switching element, comprising:
detecting that a predetermined period of time has elapsed from an initiation of a switching operation of the switching element;
performing a voltage comparison between an output voltage from the voltage generation circuit and a predetermined test voltage when it is detected that the predetermined period of time has elapsed; and
stopping a switching operation of the switching element when as a result of the voltage comparison, an output voltage from the voltage generation circuit is lower than a test voltage.

9. The power supply apparatus according to claim 2, wherein the control circuit performs the switching operation of the switching element with a predefined fixed duty during a predetermined starting period from the initiation of the switching operation.

10. The power supply apparatus according to claim 2, wherein the control circuit stops not only the switching operation of the switching element but also the load circuit connected to the output terminal of the voltage generation circuit.

11. An electronic apparatus comprising:
a battery; and
the power supply apparatus according to claim 2 which steps up or down a voltage of the battery for output.
